(19) United States
(12) Patent Application Publication
(10) Pub. No.: US 2012/0288684 A1
(43) Pub. Date: Nov. 15, 2012

(54) BUMP STRUCTURE AND FABRICATION METHOD THEREOF

(76) Inventors: Ming-Teng Hsieh, New Taipei City (TW); Yi-Nan Chen, Taipei City (TW); Hsien-Wen Liu, Taoyuan County (TW)

(21) Appl. No.: 13/106,841

(22) Filed: May 12, 2011

(51) Int. Cl. B32B 3/00; B23K 1/20; B23K 31/02

(52) U.S. Cl. 428/172; 228/160

(57) ABSTRACT

A bump structure including a base portion, an inlaid wire segment, and a protruding tail segment is provided. The base portion is bonded on a bonding site. The inlaid wire segment is pressed into a top surface of the base portion. The protruding tail segment extends from the inlaid wire segment. The methods for forming the bump structure are also provided.

### BACKGROUND OF THE INVENTION

1. Field of the Invention

The present invention relates generally to a bump structure and fabrication method thereof, and more specifically, to a bump structure fabricated by a wire bonder.

2. Description of the Prior Art

In a semiconductor process, wire bonding for electrically connecting an input/output pad of a semiconductor chip with a lead of a leadframe or a bonding pad of a package substrate is commonly used. Typically, a wire-bonding process includes the following steps. Firstly, an initial ball is formed at a tip end of a wire passing through a capillary and the initial ball is pressure-bonded onto a pad of the semiconductor chip, thereby a pressure-bonded ball is formed on the pad of the semiconductor chip. Thereafter, the capillary is moved upward to a predetermined height away from the pressure-bonded ball, and then the capillary is moved toward a bonding site on a leadframe or a substrate, thereby the wire electrically and mechanically connects the pad of a semiconductor chip and the leadframe or the substrate.

FIG. 1 is an enlarged sectional view of a conventional semiconductor package utilizing the above-described wire-bonding technique. As shown in FIG. 1, a package 100 includes a semiconductor chip 110, a wire 120, and a bonding site 134 of a leadframechip carrier 130. The chip 110 may be bonded to the chip carrier 130 by an adhesive. The wire 120 electrically connects the chip 110 with the bonding site 134. More specifically, one end E1 of the wire 120 is bonded onto a pad 115 of the chip 110 while the other end E2 of the wire 120 is bonded onto the bonding site 134.

Conventionally, the wire 120 has a curved shape including a pressure-bonded portion 122, a neck portion 124 and a bending portion 126. The neck portion 124 extends upward from the pressure-bonded portion 122 and connects the pressure-bonded portion 122 with the bending portion 126. The bending portion 126 is reversed and bent toward the bonding site 134. Since the neck portion 124 is the weakest segment of the wire 120, the loop height H1 of the wire 120 must be high enough to prevent the neck portion 124 from being damaged or broken. However, this poses a problem that the size of the package 100 using wire bonding as a whole can not be made small due to the limitation of the loop height H1 of the wire 120.

### SUMMARY OF THE INVENTION

According to a preferred embodiment of the present invention, a method for forming a bump on a bonding site is disclosed. A wire-bonder including a capillary for forming an initial ball at a tip end of a wire passing through the capillary is provided. The capillary above the bonding site is moved and the initial ball is pressure-bonded onto the bonding site, thereby a base portion of the bump is formed. The capillary is moved upward by a first distance. After the capillary is moved upward, the capillary is laterally shifted by a second distance in a first direction. The capillary is moved downward to press the wire into the base portion of the bump; thereby an inlaid first wire segment is formed. The capillary is moved upward by a third distance. The wire is cut off; thereby a protruding tail segment extending from the inlaid first wire segment is formed.

According to another preferred embodiment of the present invention, a method for forming a bump on a bonding site includes the following. A capillary of a wire-bonder above the bonding site is moved and an initial ball from the capillary is pressure-bonded to the bonding site, thereby a base portion of the bump is formed. A wire from the capillary is pressed into the base portion of the bump; thereby an inlaid wire segment is formed. The capillary is lifted and the wire is cut off, thereby a protruding tail segment extending from the inlaid wire segment is formed.

From another aspect of the present invention, a bump structure including a base portion, an inlaid wire segment, and a protruding tail segment is provided. The base portion is bonded on a bonding site. The inlaid wire segment is pressed into a top surface of the base portion. The protruding tail segment extends from the inlaid wire segment.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is an enlarged sectional view of a conventional semiconductor package utilizing the above-described wire-bonding technique.

FIG. 2 depicts an enlarged, sectional view and top view of a bump structure in accordance with a preferred embodiment of the present invention.

FIGS. 3A-3I are schematic, sectional views showing a method of forming a bump structure of FIG. 2 in accordance with a preferred embodiment of the present invention.

FIG. 4 schematically depicts a sectional view of a wire bonding package utilizing the bump structure of FIG. 2 in accordance with an embodiment of the present invention.

FIG. 5 schematically depicts a sectional view of a flip chip bonding package applying the bump structure of FIG. 2 in accordance with an embodiment of the present invention.

FIG. 6 schematically depicts a sectional view of a stacked chip package applying the bump structure of FIG. 2 in accordance with an embodiment of the present invention.

FIG. 7 schematically depicts a sectional view of a stacked chip package utilizing the bump structure of FIG. 2 in accordance with an embodiment of the present invention.

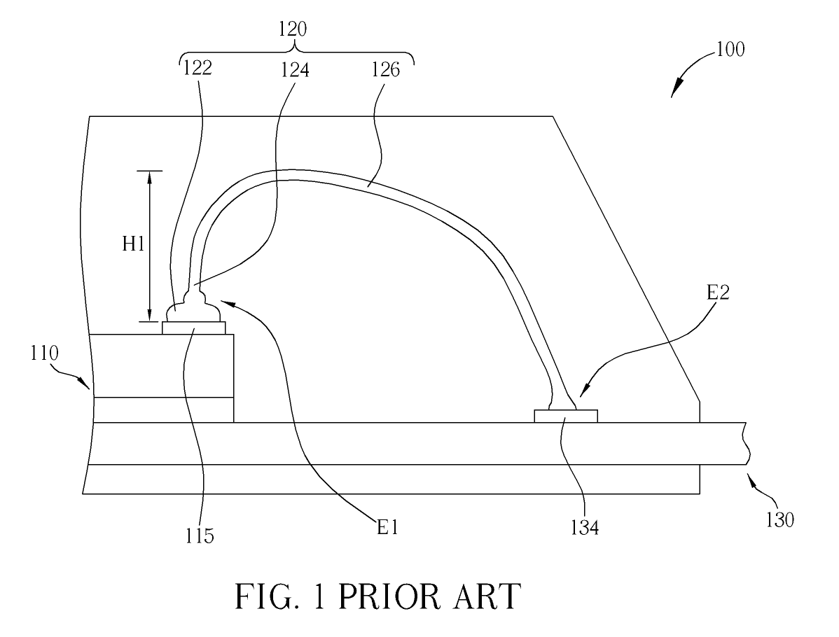

### DETAILED DESCRIPTION

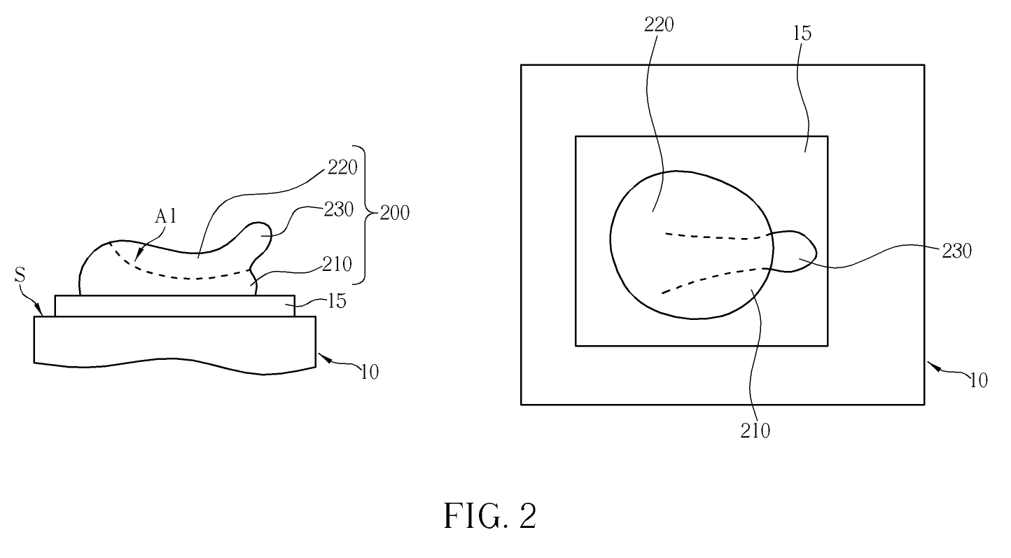

FIG. 2 depicts an enlarged, sectional view and top view of a bump structure in accordance with a preferred embodiment of the present invention. As shown in FIG. 2, a bump structure 200 is formed on a bonding site 15 such as an input/output (I/O) pad of an integrated circuit die 10. For example, the bump structure 200 may be formed on bonding site of a chip carrier such as a lead of a leadframe or a bonding pad of a package substrate.

The bump structure 200 includes a base portion 210, an inlaid wire segment 220 and a protruding tail segment 230. In this embodiment, the base portion 210 is bonded on the pad 15 on an active side S of an integrated circuit die 10. In another embodiment, the base portion 210 may be bonded on a bonding site such as a pad of a lead of a leadframe, a pad of a substrate, etc., but it is not limited thereto. The inlaid wire segment 220 is pressed into a top surface A1 of the base portion 210. The protruding tail segment 230 extends from the inlaid wire segment 220.

In a preferred embodiment, the inlaid wire segment 220 is inlaid in the top surface A1 of the base portion 210 so that the bump structure 200 can be rigidly fixed on the pad 15. The base portion 210, the inlaid wire segment 220 and the protruding tail segment 230 are made of conductive materials, such as metals. Generally, the base portion 210, the inlaid wire segment 220 and the protruding tail segment 230 are formed in one piece. The base portion 210, the inlaid wire segment 220 and the protruding tail segment 230 are made of the same conductive material, such as metal like gold or copper.

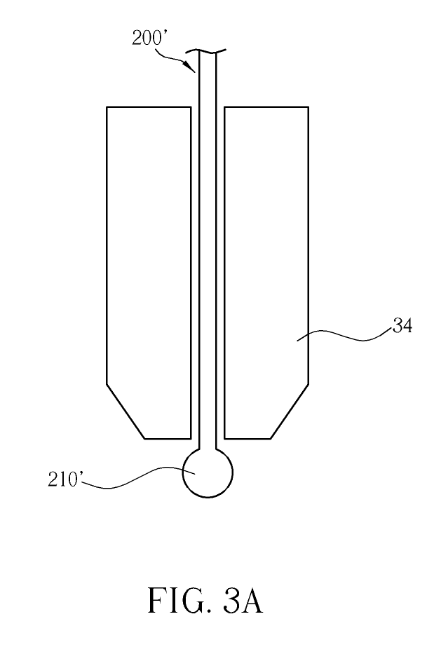

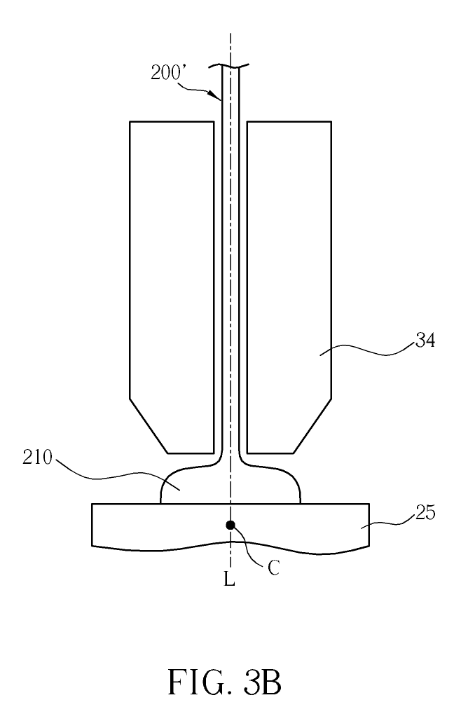

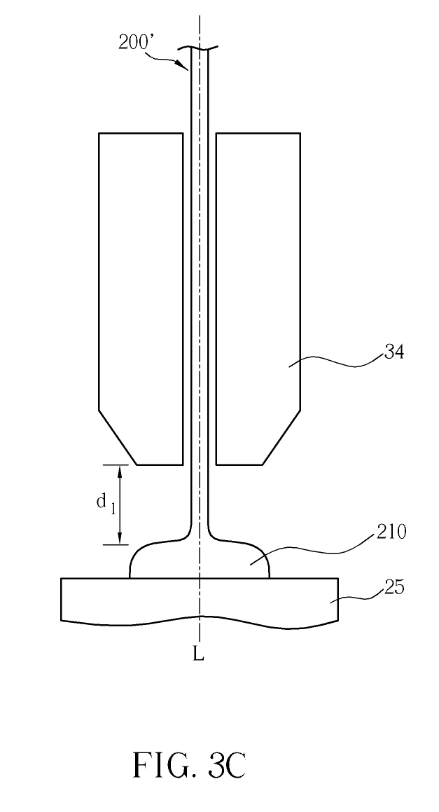

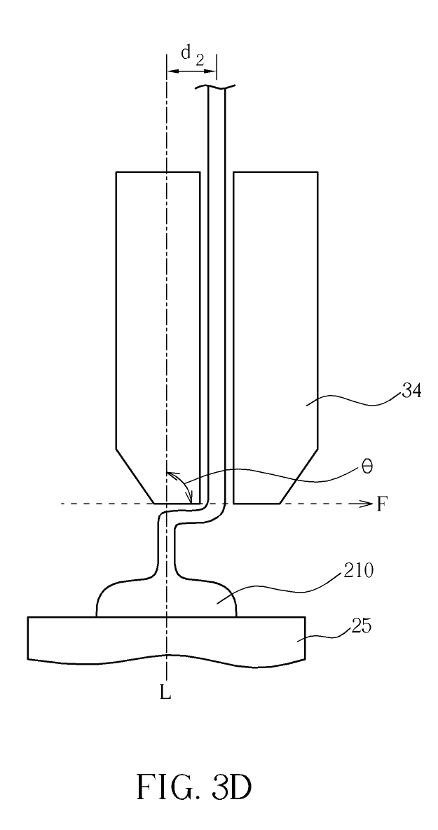

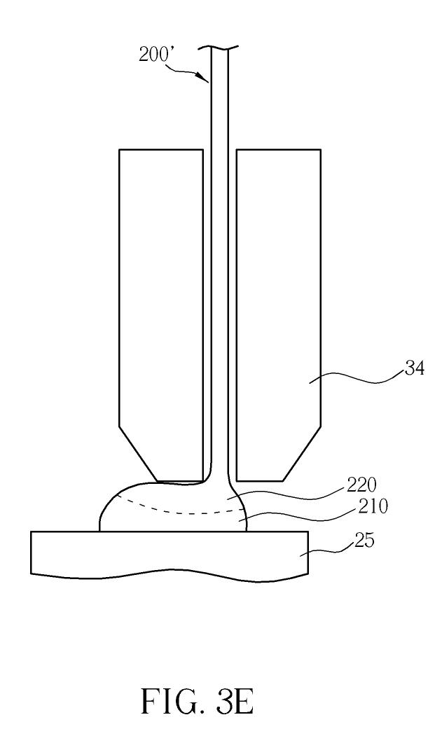

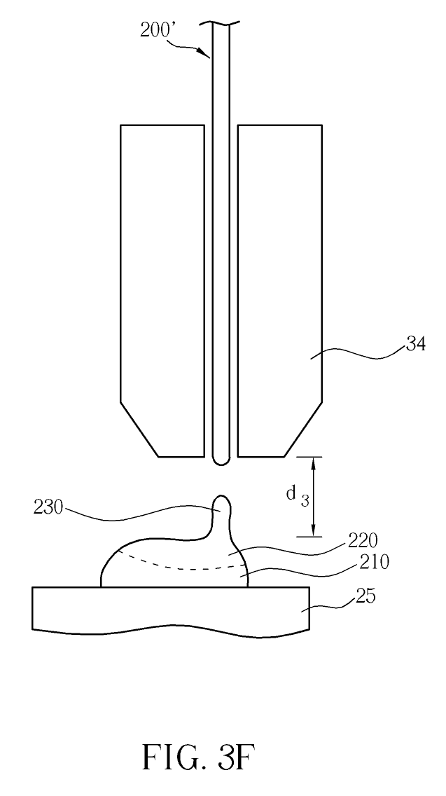

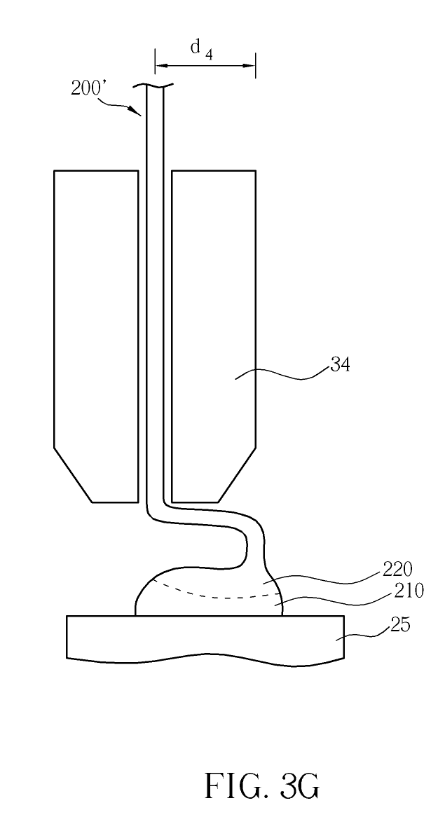

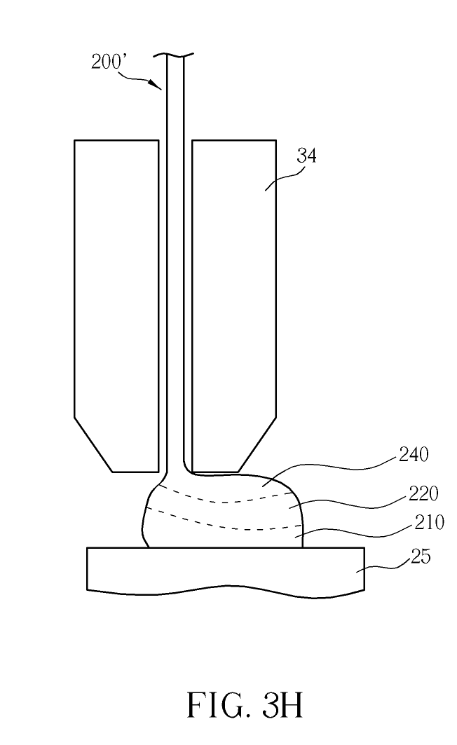

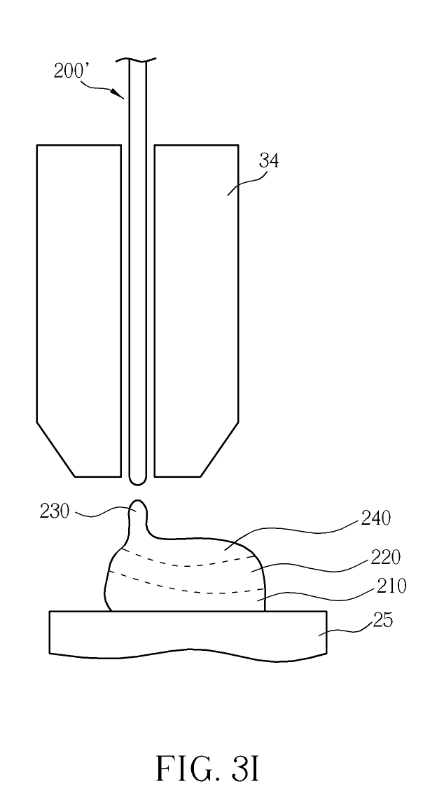

FIGS. 3A-3F are schematic, sectional views showing a method of forming a bump structure of FIG. 2 in accordance with a preferred embodiment of the present invention. As shown in FIG. 3A, a wire-bonder 30 is provided, which includes a capillary 34 having a wire 200′ passing therethrough. An initial ball 210′ may be formed at a tip end of the wire 200′, wherein the wire 200′ is a gold wire, a copper wire, or any suitable conductive wire.

As shown in FIG. 3B, after the initial ball 210′ is formed, the capillary 34 is moved above a bonding site 25 and then moved downward to pressure-bond the initial ball 210′ onto the bonding site 25, thereby a base portion 210 is formed on the bonding site 25. The bonding site 25 may be an I/O bond pad on an active side of an integrated circuit die, a lead of a leadframe, or a bonding pad of a package substrate, for example. In this embodiment, it is preferred to move the capillary 34 right above the center C of the bonding site 25 and then the capillary 34 is moved downward along a center line L of the bonding site 25. In another embodiment, the initial relative position between the capillary 34 and the bonding site 25 is dependent on the process requirements.

As shown in FIG. 3C, the capillary 34 is moved upward by a first distance d1 along the center line L of the bonding site 25. As shown in FIG. 3D, the capillary 34 is laterally shifted by a second distance d2 in a first direction F. In some cases, the capillary 34 may be moved by an angle θ relative to the center line L. In this case, the capillary 34 is horizontally (essentially vertical with the center line L) shifted. In other words, the capillary 34 is moved by the angle θ of 90 degrees relative to the center line L in this case.

As shown in FIG. 3E, the capillary 34 is moved downward to press the wire 200′ into the base portion 210, thereby an inlaid first wire segment 220 is formed on the base portion 210.

As shown in FIG. 3F, the capillary 34 is moved upward by a third distance d3 and then the wire 200′ is cut off, thereby a protruding tail segment 230 extending from the inlaid first wire segment 220 is formed. Therefore, a bump structure 200 having the base portion 210, the inlaid first wire segment 220, and the protruding tail segment 230 is formed. That is, the base portion 210, the inlaid wire segment 220 and the protruding tail segment 230 are formed in one piece by the wire bonder 30.

In a preferred embodiment, the inlaid wire segment 220 is embedded into the base portion 210 so that the bump structure 200 can be rigidly fixed on the bonding site 25. In this embodiment, the wire 200′ is pulled apart by the movement of the capillary 34. In other embodiments, the wire 200′ may be cut off by burning, arc cutting, oxyhydrogen cutting, etc. The base portion 210, the inlaid wire segment 220 and the protruding tail segment 230 are made of conductive materials, such as metals. In a preferred embodiment, the base portion 210, the inlaid wire segment 220 and the protruding tail segment 230 are made of the same conductive material, such as metal like gold or copper.

Furthermore, before the wire 200′ is cut off, the capillary 34 may be also laterally shifted more than one time for bending the wire 200′. The steps of the capillary 34 shifting can be performed by combinations of the steps of being moved down and up for pressing the wire 200′ onto the base portion 210 to form the second segment, the third segment, etc. For example, as shown in FIG. F-I, after moving the capillary 34 upward by the third distance d3 (as shown in FIG. 3F), the capillary 34 may be laterally shifted by a fourth distance d4 in a second direction that is opposite to the first direction F (as shown in FIG. 3G). Then, the capillary 34 may be moved downward to press the wire 200′, again, into the inlaid first wire segment 220, thereby forming an inlaid second wire segment 240 (as shown in FIG. 3H). Finally, the capillary 34 is moved upward and then the wire 200′ is cut off, thereby a protruding tail segment 230 extending from the inlaid second wire segment 240 is formed (as shown in FIG. 3I).

The bump structure 200 can be applied to, but is not limited to, packages such as a wire bonding package, a flip chip package, and a wire bonding paired with flip chip package. Four examples are described below, but the present invention is not limited thereto.

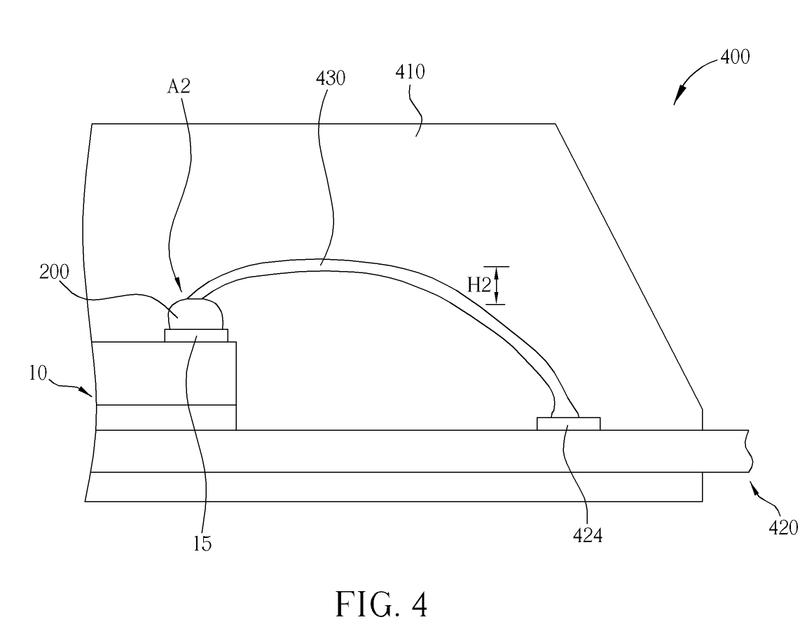

The bump structure 200 when used in a wire bonding package can reduce the size of the package compared to conventional wire bonding package. FIG. 4 schematically depicts a sectional view of a wire bonding package utilizing the bump structure of FIG. 2 in accordance with an embodiment of the present invention. As shown in FIG. 4, for example, a package 400 includes a leadframe 420, an integrated circuit die 10 adhered on a die pad of the leadframe 420, a first wire 430, and a mold cap 410. The bump structure 200 is formed on the integrated circuit die 10 by the method illustrated through FIGS. 3A-3F. One end of the first wire 430 is bonded into a top surface A2 of the bump structure 200 while the other end of the first wire 430 is bonded onto the lead 422, so as to connect the first wire 430 of the integrated circuit die 10 with the leadframe 420, wherein the first wire 430 may be bonded into the top surface A2 of the bump structure 200 by pressing, heating, or other methods. In this way, the loop shape of the first wire 430 does not have a neck portion 120 of the prior art, so that damaged or broken neck portions are prevented. The height H2 of the package 400 is also reduced. As a result, the thickness of the package 400 shrinks.

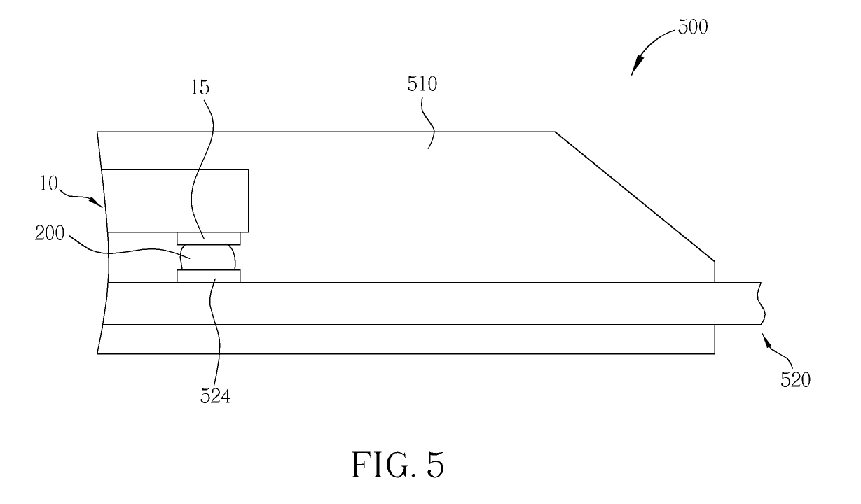

Furthermore, the bump structure 200 can also be applied to a flip chip bonding package. FIG. 5 schematically depicts a sectional view of a flip chip bonding package applying the bump structure of FIG. 2 in accordance with an embodiment of the present invention. As shown in FIG. 5, for example, a package 500 includes a chip carrier 520, an integrated circuit die 10, and a mold cap 510. The integrated circuit die 10 is connected to the bonding pad 524 via the bump structure 200. For example, the bump structure 200 is firstly bonded on the pad 15 of the integrated circuit die 10 by the method illustrated through FIGS. 3A-3F. Thereafter, the integrated circuit die 10 is flipped and aligned to the bonding pad 524. Then, the bump structure 200 is bonded onto the bonding pad 524 of the chip carrier 520, therefore flip chip bonding between the integrated circuit die 10 and the chip carrier 520 is completed.

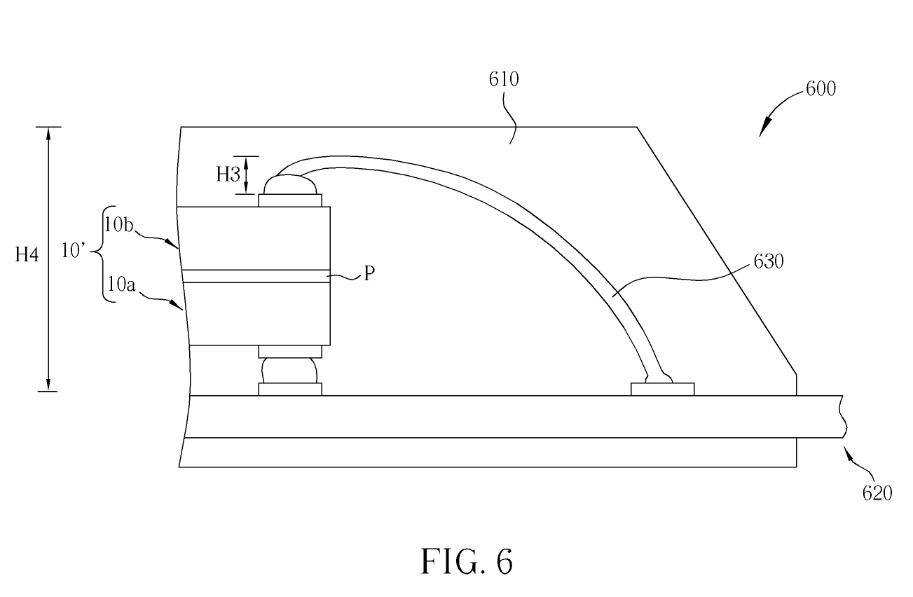

FIG. 6 schematically depicts a sectional view of a stacked chip package applying the bump structure of FIG. 2 in accordance with an embodiment of the present invention. As shown in FIG. 6, a package 600 includes a stacked integrated circuit die 10′, a chip carrier 620, a second wire 630, and a mold cap 610. The stacked integrated circuit die 10′ includes a first integrated circuit die 10a and a second integrated circuit die 10b adhered on a back side of the first integrated circuit die 10a by an adhesive p. The first integrated circuit die 10a is connected to the chip carrier 620 using the bump structure 200 of FIG. 2 and the flip-chip method. The second integrated circuit die 10b is connected to the chip carrier 620 using the bump structure 200 of FIG. 2 and the wire-bonding method. By this method for forming the stacked chip package 600, the height H4 of the package 600 is reduced because the loop height H3 of the second wire 630 connecting the second integrated circuit die 10b with the lead 522 is reduced and the manufacturing process is simplified due to flip chip bonding and wire bonding using in the package 600.

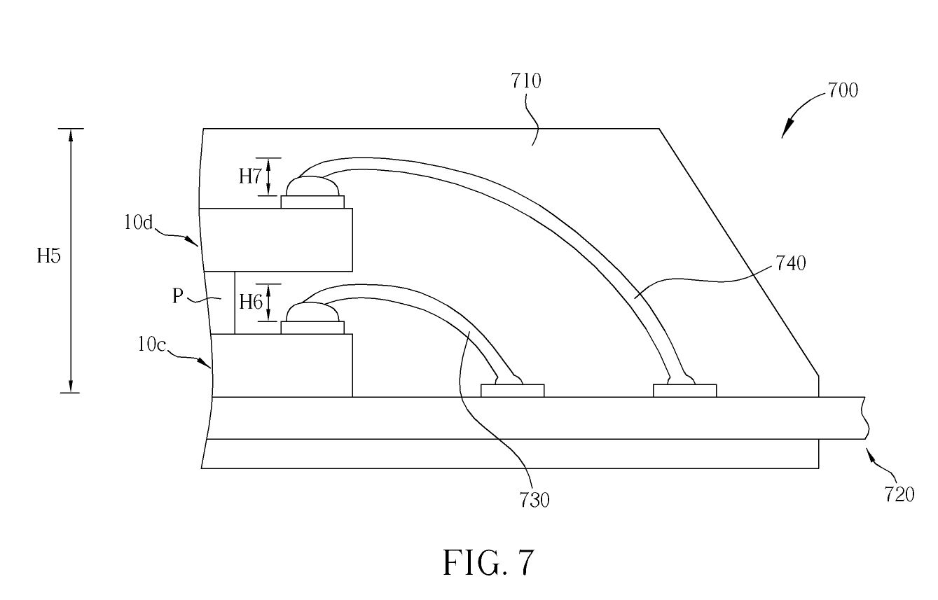

FIG. 7 schematically depicts a sectional view of a stacked chip package utilizing the bump structure of FIG. 2 in accordance with an embodiment of the present invention. As shown in FIG. 7, for example, a package 700 includes a stacked integrated circuit die 10″, a chip carrier 720, a third wire 730, a forth wire 740, and a mold cap 710. The stacked integrated circuit die 10″ includes a third integrated circuit die 10c and a forth integrated circuit die 10d adhered on the third integrated circuit die 10c by an adhesive p. The third integrated circuit die 10c and the forth integrated circuit die 10d are respectively connected to the chip carrier 720 via the third wire 730 and the forth wire 740. The height H5 of the package 700 is reduced because the loop height HE of the third wire 730 and the loop height H7 of the forth wire 740 is reduced. Besides, the third wire 730 and the forth wire 740 can avoid being damaged or broken because the loop shapes of the third wire 730 and the forth wire 740 do not have a neck portion 120 of the prior art. Therefore, the size of the package 700 shrinks while the performance of the package 600 is improved.

Those skilled in the art will readily observe that numerous modifications and alterations of the device and method may be made while retaining the teachings of the invention.

What is claimed is:

1. A method for forming a bump on a bonding site, comprising:
providing a wire-bonder comprising a capillary for forming an initial ball at a tip end of a wire passing through the capillary;
moving the capillary above the bonding site and pressure-bonding the initial ball onto the bonding site, thereby forming a base portion of the bump;
moving the capillary upward by a first distance;
after moving the capillary upward, laterally shifting the capillary by a second distance in a first direction;
moving the capillary downward to press the wire into the base portion of the bump, thereby forming an inlaid first wire segment;
moving the capillary upward by a third distance; and
cutting the wire off thereby forming a protruding tail segment extending from the inlaid first wire segment.

2. The method for forming a bump on a bonding site according to claim 1, wherein after moving the capillary upward by the third distance, the method further comprises: laterally shifting the capillary by a fourth distance in a second direction that is opposite to the first direction.

3. The method for forming a bump on a bonding site according to claim 2, wherein after laterally shifting the capillary by the fourth distance, the method further comprises: moving the capillary downward to press the wire into the inlaid first wire segment of the bump, thereby forming an inlaid second wire segment.

4. The method for forming a bump on a bonding site according to claim 1, wherein the bonding site is an input/output (I/O) bond pad disposed on an active side of an integrated circuit die.

5. The method for forming a bump on a bonding site according to claim 1, wherein the wire is a gold wire.

6. The method for forming a bump on a bonding site according to claim 1, wherein the wire is a copper wire.

7. A method for forming a bump on a bonding site, comprising:
moving a capillary of a wire-bonder above the bonding site and pressure-bonding an initial ball from the capillary to the bonding site, thereby forming a base portion of the bump;
pressing a wire from the capillary into the base portion of the bump, thereby forming an inlaid wire segment; and
lifting the capillary and cutting the wire off thereby forming a protruding tail segment extending from the inlaid wire segment.

8. The method for forming a bump on a bonding site according to claim 7, wherein before pressing the wire from the capillary into the base portion of the bump, the method further comprises: laterally shifting the capillary by a predetermined distance.

9. The method for forming a bump on a bonding site according to claim 7, wherein the bonding site is an input/output (I/O) bond pad disposed on an active side of an integrated circuit die.

10. The method for forming a bump on a bonding site according to claim 7, wherein the wire is a gold wire.

11. The method for forming a bump on a bonding site according to claim 7, wherein the wire is a copper wire.

12. A bump structure, comprising:
a base portion bonded on a bonding site;
an inlaid wire segment pressed into a top surface of the base portion; and
a protruding tail segment extending from the inlaid wire segment.

13. The bump structure according to claim 12, wherein the base portion, the inlaid wire segment and the protruding tail segment are made of a same conductive material.

14. The bump structure according to claim 13, wherein the conductive material is gold.

15. The bump structure according to claim 13, wherein the conductive material is copper.

16. The bump structure according to claim 12, wherein the bonding site is an input/output (I/O) bond pad disposed on an active side of an integrated circuit die.
